(19) United States
(12) Patent Application Publication
(10) Pub. No.: US 2015/0338363 A1
(43) Pub. Date: Nov. 26, 2015

(54) CAPACITIVE FRINGING FIELD SENSORS AND ELECTRICAL CONDUCTIVITY SENSORS INTEGRATED INTO PRINTED CIRCUIT BOARDS

(71) Applicant: AUBURN UNIVERSITY, Auburn, AL (US)

(72) Inventors: Robert Neal DEAN, JR., Auburn, AL (US); Elizabeth Ann GUERTAL, Auburn, AL (US); Michael Edward BAGINSKI, Auburn, AL (US)

(73) Assignee: AUBURN UNIVERSITY, Auburn, AL (US)

(21) Appl. No.: 14/711,437

(22) Filed: May 13, 2015

Related U.S. Application Data
(60) Provisional application No. 61/992,666, filed on May 13, 2014.
(60) Provisional application No. 62/076,605, filed on Nov. 7, 2014.

(51) Int. Cl. G01N 27/22; G01W 1/00; B64D 15/20

(52) U.S. Cl. CPC G01N 27/221; B64D 15/20; G01W 1/00

(57) ABSTRACT

A device is provided for sensing the chemical composition of soils and aqueous solutions. The device includes a capacitive fringing field interdigitated electrode sensor integrated into the printed circuit board and configured to sense an electrical impedance. The device also includes an electrical conductivity sensor integrated into the printed circuit board and configured to sense an electrical conductivity. The sensed electrical impedance and electrical conductivity are indicative of chemical properties. The capacitive fringing field interdigitated electrode sensor may also be used to detect the accumulation of ice.

### CROSS-REFERENCE TO RELATED APPLICATIONS

This application claims the benefit of U.S. Provisional Patent Application Ser. No. 61/992,666, filed May 13, 2014, and U.S. Provisional Patent Application Ser. No. 62/076,605, flied Nov. 7, 2014. Both of these provisional applications are incorporated herein in their entirety for all purposes.

### TECHNICAL FIELD

This invention relates generally to the field of sensors; and more particularly to devices integrated into printed circuit boards for sensing signals indicative of the chemical properties of soil and aqueous solutions and for detecting ice accumulation.

### BACKGROUND

Soil consists of inorganic and organic (living and dead) constituents, along with bound and free water, and air. Soil particles are classified as sand (50 μm to 2 mm particle size), silt (2 μm to 50 μm particle size) and clay (particle size less than 2 μm). Soil moisture is typically expressed with regard to its availability to plants as a function of soil water-holding capacity. Soil water holding capacity is largely a function of texture and porosity. Soils with greater clay content and smaller pores will hold more water against gravity, and most of that water will be available to a plant for a greater period of time. Sandy soils with high macropore contents will drain quickly and dry, causing a plant to wilt more quickly. Soil moisture sensors must be able to detect these changes in soil-water content and do so effectively over a range of plant-available water.

The presence of salts (KCl, NaCL, NaNO₃, etc.), in the soil can greatly affect soil stability and crop growth, through ion competition and fertilizer nutrient uptake, and through destabilization of soil structure, which affects porosity and water infiltration. Salt affected soils are one of the greatest threats to crop production, and reliable and inexpensive devices and techniques for monitoring salt and water content in soil are greatly needed.

Ice accumulation, or icing, is a commonly occurring phenomenon, requiring moisture and sufficiently cold temperatures. Although often of little consequence, some accumulation of ice can be very problematic. For example, ice accumulation may cause damage to ice due to frost, ice accumulation on wings and other aircraft surfaces may result in hazardous operation of the aircraft, ice accumulation on roads, bridges and sidewalks may cause hazards for vehicles and pedestrians, ice or frost accumulation on compressors and associated equipment may cause such equipment to malfunction, and ice or frost accumulation in a freezer may cause the freezer not to operate properly. Reliable and inexpensive devices and techniques for monitoring the accumulation of ice and frost are greatly needed.

### SUMMARY

According to an illustrative embodiment, a device for sensing signals indicative of the chemical properties of soil or an aqueous solution includes a capacitive fringing field interdigitated electrode sensor and an electrical conductivity sensor. The capacitive fringing field interdigitated electrode sensor and the electrical conductivity sensor are integrated into a printed circuit board. The capacitive fringing field interdigitated electrode sensor is configured to sense an electrical impedance of the soil or aqueous solution. The electrical conductivity sensor is configured to sense an electrical conductivity of the soil or aqueous solution. The sensed electrical impedance and the sensed electrical conductivity are indicative of chemical properties of the soil or aqueous solution.

According to another illustrative embodiment, a device for sensing the accumulation of ice includes a capacitive fringing field interdigitated electrode sensor integrated into a printed circuit board. The capacitive fringing field interdigitated electrode capacitance sensor is configured to sense an electrical impedance. An abrupt decrease in the sensed electrical impedance compared to water immersion is indicative of an accumulation of ice.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are explanatory of example embodiments of the invention, and are not restrictive of the invention, as claimed.

### BRIEF DESCRIPTION OF THE DRAWINGS

FIG. 1 illustrates a configuration of two parallel plate electrodes.

FIG. 2 illustrates electric field lines between the two parallel plate electrodes shown in FIG. 1, with the fringing effect ignored.

FIG. 3 illustrates a configuration of two parallel plate electrodes with the electric field lines, including the edge effect fringing fields.

FIG. 4 illustrates two parallel plate electrodes in a configuration with edge fringing effects that are more substantial than those shown in FIG. 3.

FIG. 5 shows a top view of two interdigitated electrodes.

FIG. 6 shows a cross-sectional view of a two-layer printed circuit board (PCB).

FIG. 7 shows a cross-sectional view of interdigitated electrodes patterned in Cu foil on one side of a PCB.

FIG. 8 shows a cross-sectional view of interdigitated electrodes patterned in Cu foil on one side of a PCB with lines representing the electric field lines between the electrodes.

FIG. 9a illustrates a capacitive fringing field interdigitated electrode structure according to an illustrative embodiment.

FIG. 9b illustrates an implementation of a capacitive fringing field interdigitated electrode sensor integrated into a PCB according to an illustrative embodiment.

FIG. 10 illustrates a plot of a measured capacitance versus mass using an interdigitated electrode capacitance sensor.

FIG. 11 shows a cross-section view of an electrical conductivity (EC) sensor integrated in a PCB according to an illustrative embodiment.

FIG. 12 illustrates a plot of an electrical conductivity sensor response to in water with the addition of NaCl.

FIG. 13 illustrates a PCB sensing device for sensing signals indicative of chemical properties according to an illustrative embodiment.

FIG. 14 is a plot of a measured capacitance versus water content of soil.

FIGS. 15a and 15b illustrate implementation of a horizontally arranged interdigitated electrode structure and a vertically arranged interdigitated electrode sensor, respectively, according to an illustrative embodiment.

### DETAILED DESCRIPTION

The present invention may be understood more readily by reference to the following detailed description taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

According to illustrative embodiments, capacitive fringe field sensors are integrated into a printed circuit board (PCB), along with other sensors, resulting in sensors that are effective and reliable for soil content sensing and ice accumulation sensing. To aid in understanding of the illustrative embodiments described herein, an overview of capacitive fringe field sensing, PCB technology and electrical conductivity sensing is provided below.

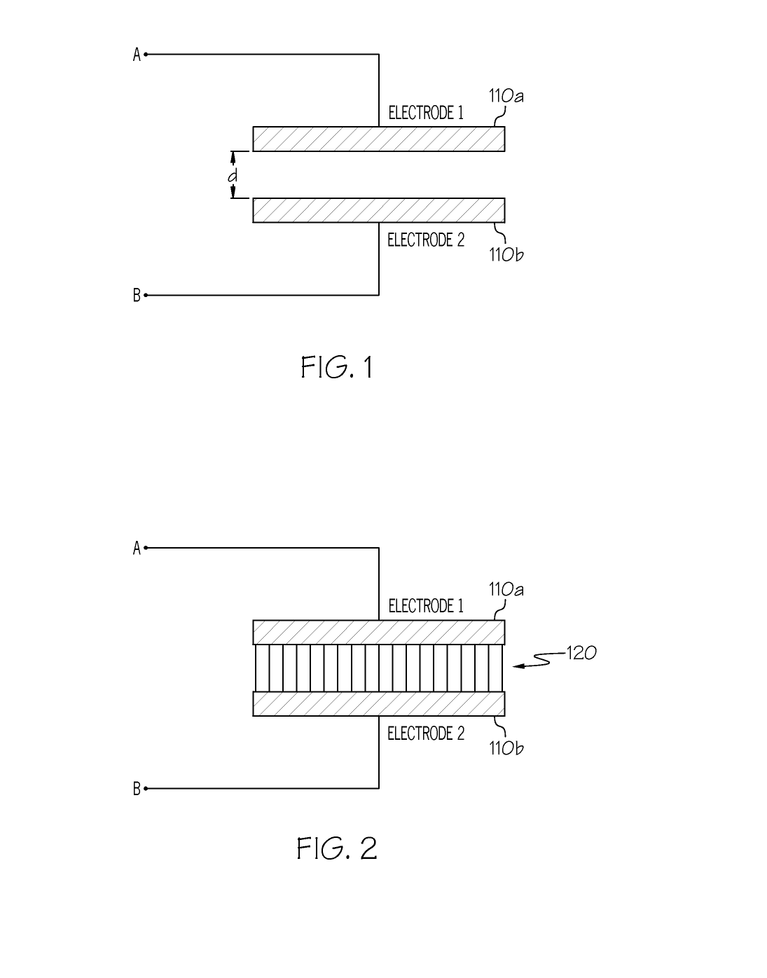

FIG. 1 illustrates a parallel plate capacitor with two parallel plate electrodes 110a and 110b of overlapping area, a, and separation distance, d, filled with dielectric material. The dielectric material has a relative permittivity, εᵣ, and resides in the space between and around the two electrode plates 110a and 110b. The capacitance between the two electrode plates 110a and 110b can be measured at the electrical connection points labeled “A” and “B.” Ignoring fringing, the equation for the capacitance, C, between the two electrodes is:

$$C = \frac{{ɛ}_{o} {ɛ}_{r} a}{d} \qquad ( 1 )$$

where εₒ, is the permittivity of free space, 8.854 pF/m.

Lines 120 representing the electric field between the two electrodes (ignoring fringing) are shown in FIG. 2. In FIG. 2, the maximum feature size k may be considered to be the length of the electrode plates 110a and 110b. For the case where the minimum feature size of the electrode area, a, can be approximated by k where k≈\sqrt{a} (assuming that the plate area is nearly square or round) and k is much greater in magnitude than the separation distance between the electrodes (k>>d), Eqn. (1) is a reasonable approximation for the capacitance between the two electrodes.

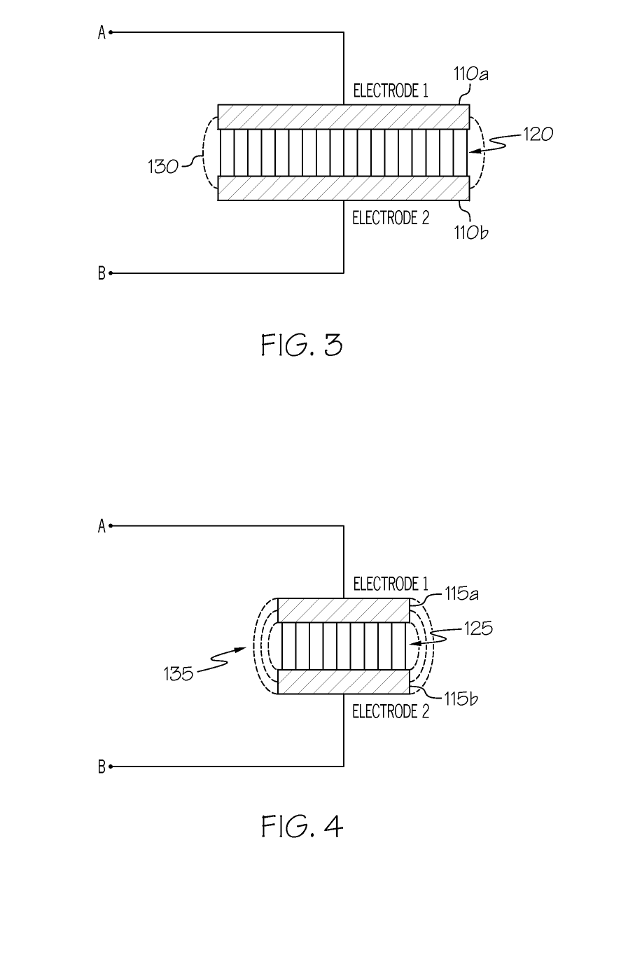

FIG. 3 shows lines 130 representing the fringing fields in the region outside of the overlapping area between the two electrode plates 110a and 110b. Fringing has the effect of increasing the capacitance. Adding a fringing scale factor to Eqn. (1), when appropriate, to account for the fringing effects, results in the following capacitance:

$$C = \frac{{ɛ}_{o} {ɛ}_{r} a γ}{d} \qquad ( 2 )$$

where γ is a scale factor that accounts for the increase in capacitance due to fringing and is never less than one.

If the geometry of the two electrode plates is altered so that the maximum feature size, k, is not significantly greater than the separation distance d between the electrode plates, then fringing effects represent a much larger portion of the total capacitance between the two electrodes. This is illustrated in FIG. 4 which shows electrode plates 115a and 115b having a maximum feature size, k, (e.g., length) that is not significantly greater than the distance d between the electrode plates 115a and 115b. As can be seen from FIG. 4, this configuration results in electric field lines 125 between the electrode plates 115a and 115b with more fringing field lines 135 outside the overlapping area between the electrode plates.

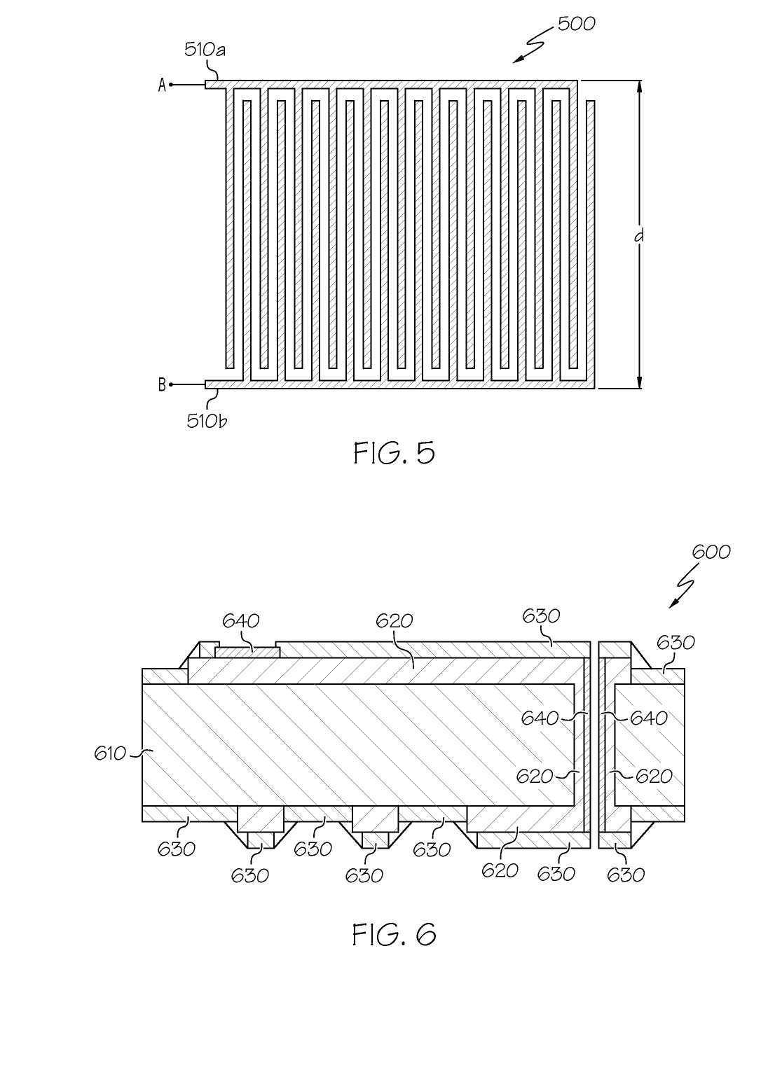

Turning now to an overview of interdigitated electrode structures, consider a structure where n electrodes of area, a, are stacked in parallel, with a fixed separation distance, d, apart, in a dielectric material of relative permittivity, εᵣ, as illustrated in FIG. 5. Every other stacked electrode is electrically connected together. This electrode configuration is referred to as an interdigitated electrode structure and includes two interdigitated electrodes with arms 510a and 510b as shown in the top-view illustration of FIG. 5.

Assuming that the minimum feature size, k, of the overlapping area, a, of the electrodes 510a and 510b is much greater than the electrode separation distance, d, most of the capacitance between the electrodes is associated with the electric field contained directly between the electrodes' overlapping areas, a, and not due to the effects of fringing. However, in the configuration shown in FIG. 5, considering k to be the height of the electrodes, k is not much greater than d. Thus, the fringing effects will be considerably greater.

For n interdigitated electrodes, the equation for the capacitance is given as:

$$C = \frac{( n - 1 ) {ɛ}_{o} {ɛ}_{r} a γ}{d} \qquad ( 3 )$$

Eqn. (3) does not account for multiple dielectric materials with different relative permittivity values or for any additional stray capacitance between the electrode plates and the arms to which the opposite electrode plates are physically attached. If the height of the electrodes is on the same order as the separation distance, much of the capacitance will be due to the fringing fields outside of the space directly between the interdigitated electrodes.

Capacitor structures, such as those described above, can be utilized as sensors for numerous applications. Any measurand that affects the electrode separation distance, the electrode overlapping area or the relative permittivity of the dielectric between the electrodes can be sensed with a capacitor structure. Additionally, if a measurand interacts with the fringing fields, thereby changing the measurable capacitance, a useful sensor can also be realized.

Fringing field capacitive detection has the advantage of allowing the electrodes to be physically isolated from the sensing environment, as the fringing electric field is projected into the object or material being detected without altering the electrode configuration. Interdigitated electrode structures are particularly suitable for this sensing technique, as they can be designed to maximize the capacitance due to fringing.

Capacitive fringing field sensors have been developed for measuring soil moisture content and grain moisture content, detecting rain, as proximity sensors, as capacitive touch switches, as biomedical sensors and as a sensing element in a Micro-Electro-Mechanical Sensor (MEMS) accelerometer. Many of these sensors operate by measuring the change in capacitance due to the fringing fields in air (εᵣ32 1.0006) and in water (εᵣ32 80). Since the ratio of relative permitivities of water and air is approximately 80:1, there is typically a very large change in capacitance due to the presence of water or an object containing water.

Turning now to printed circuit board technology, standard printed circuit boards (PCBs) consist of a dielectric substrate that has conductive traces on at least one surface that are used for electronic component attachment and electrical interconnection. If a PCB has traces on only one side, it is called a single-sided or a single layer board. If the PCB has traces on both sides, it is called a double-sided or a 2-layer board. A PCB with additional internal layers of traces is called a multilayer PCB.

A PCB substrate may be rigid, flexible or in-between (semi-flexible or semi-rigid). FR-4 is a commonly used rigid PCB substrate material and consists of one or more layers of woven glass cloth, typically E-glass, held together by an epoxy-resin. While an FR-4 substrate is described and illustrated herein, It should be appreciated that the invention is not limited to the use of an FR-4 substrate.

Rigid PCB's have a fairly large range of thicknesses, from tens of mils to over 100 mils. For example, 62 mils is a typical thickness for a rigid PCB.

The electrical traces on a PCB are typically made by patterning a solid Cu foil layer. Typical thicknesses for the Cu foil are 0.5 oz (0.7 mils), 1.0 oz (1.4 mils) and 2 oz (2.8 mils). Traces can have minimum feature sizes as small as a few mils. Except for the portions of the traces that will be soldered to attached devices, the rest of the exposed surface of the PCB is usually coated with a polymeric material called a solder mask. The primary purpose of the solder mask is to limit the flow of solder during the soldering process. Since Cu quickly oxidizes, which can make soldering difficult, the exposed Cu traces are usually plated with a plated surface finish, such as Sn. Traces on different layers of the PCB can be electrically connected using plated through-holes.

An illustration of a cross-section of a two-layer PCB is presented in FIG. 6. As shown in FIG. 6, a PCB 600 includes a substrate 610 with Cu traces 620 on the top and the bottom of the substrate. The exposed surfaces of the Cu traces 620 and the portions of the substrate facing a through-hole or via are covered with a surface finish 640. Unexposed surfaces of the Cu traces 620 are covered with a solder mask 630.

The technology for implementing PCBs is also an excellent technology for implementing capacitive interdigitated electrode fringing field sensor structures. FR-4 and other PCB substrate materials provide a suitable platform for interdigitated electrode structures, which can be realized as Cu traces on one or both sides of a two-layer PCB. The electrodes are coated with solder mask to insulate them from the sensing environment, which is typically water based, to prevent electrical shorting. Additionally, the Cu thickness can be tailored to the solder mask thickness in order to minimize measurand-induced, non-fringing capacitive effects directly between the electrodes.

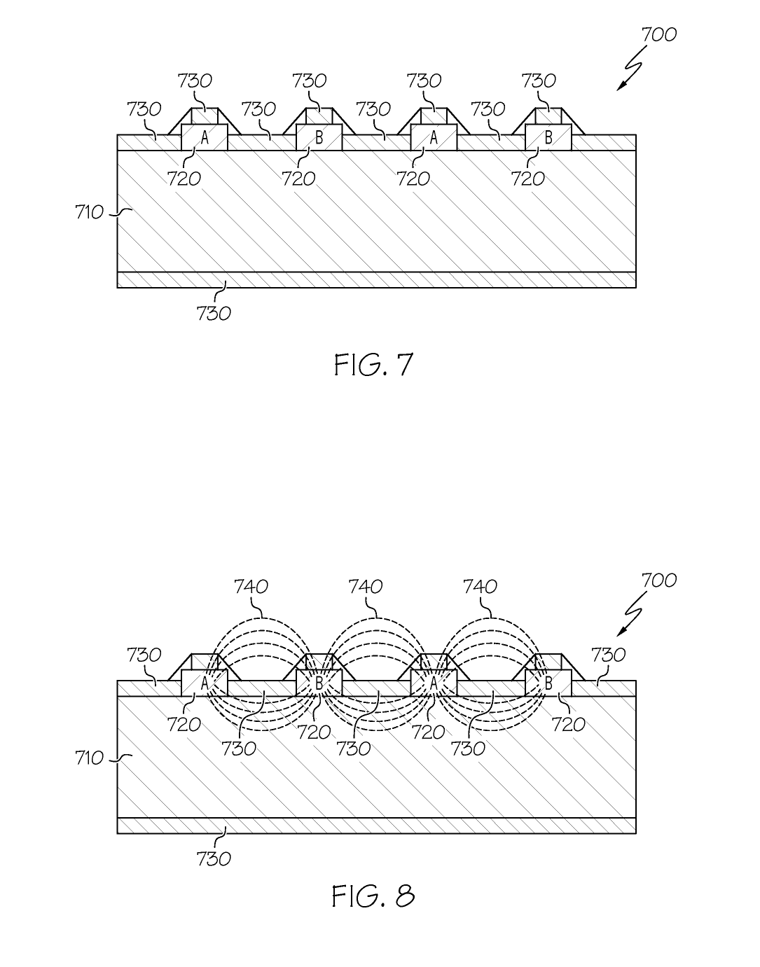

A cross-sectional view of interdigitated electrodes patterned in the Cu foil, 720, on one side of a PCB is shown in FIG. 7. In FIG. 7, interdigitated electrodes, “A” and “B”, are only realized on one side of the PCB 700 including a substrate 710. The electrodes are coated with a solder mask 730. The non-patterned side of the PCB 700 can be used for additional interdigitated electrodes, an electrical ground plane or for attaching sensor interface electronics. In the configuration shown in FIG. 7, the non-patterned side of the PCB 700 is coated with a solder mask 730.

FIG. 8 shows lines representing the fringing electric field lines 740 between the interdigitated electrodes depicted in FIG. 7.

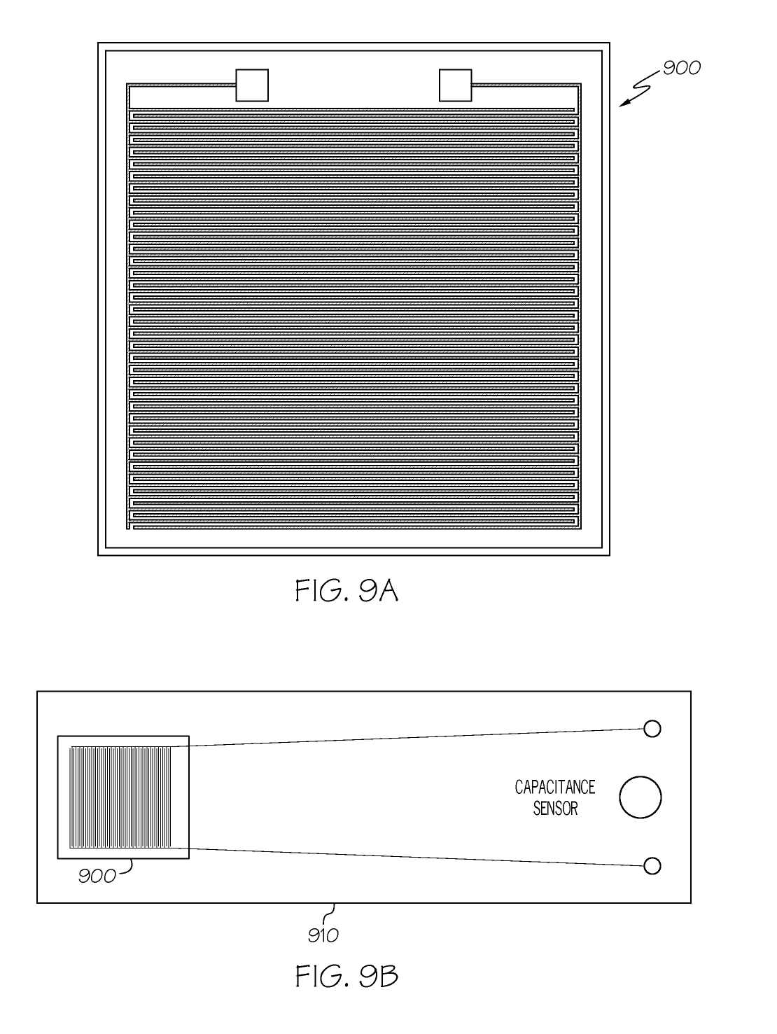

FIG. 9a illustrates a capacitive fringing field interdigitated electrode structure 900 according to an illustrative embodiment. According to an illustrative embodiment, the interdigitated electrode structure 900 may be fabricated such that it is roughly the size of a dime.

For illustrative purposes, prototype rigid PCB fringing field sensors were designed, fabricated and tested using commercially available PCBs. This process resulted in a double-layer PCB on an FR-4 substrate with 1 oz Cu traces and PSR-4000BN solder mask. The prototype devices were also fabricated by Advanced Circuits, a commercial PCB fabricator. That process resulted in a double-sided PCB that was nominally 62 mils thick, with 1.4 mil tall Cu traces and a solder mask thickness of 0.7 to 1.3 mils.

The end prototype device was 1000 mils by 1000 mils in size with an interdigitated electrode structure patterned in the Cu foil on one side. A solid Cu plane was realized on the bottom side of the device directly under the interdigitated electrode structure on the top side. The electrodes were 6 mils wide with a 6 mil gap between adjacent electrodes. This device had 70 electrodes that overlapped 882 mils. A 40 mil diameter plated through-hole was fabricated in the center of each of the two electrical contact pads.

An illustration of an interdigitated electrode structure for the prototype device is shown in FIG. 9b. As can be seen from FIG. 9b, the interdigitated electrode structure 900 rests on a PCB 910 that has solder mask openings around two contact pads. Wires were soldered into the two plated through-holes in the electrical contact pads. Then, the exposed pads/wires were coated with silicone to insulate them from contact with water, which would electrically short the two wires together. As a size comparison, the prototype interdigitated electrode structure was about the size of a dime.

In FIGS. 9a and 9b, the interdigitated electrode structure 900 is arranged horizontally with respect to the PCB 910. However, it should be appreciated that, according to an illustrative embodiment, the interdigitated electrode structure may be arranged vertically or in any desired configuration with respect to a PCB into which it is integrated.

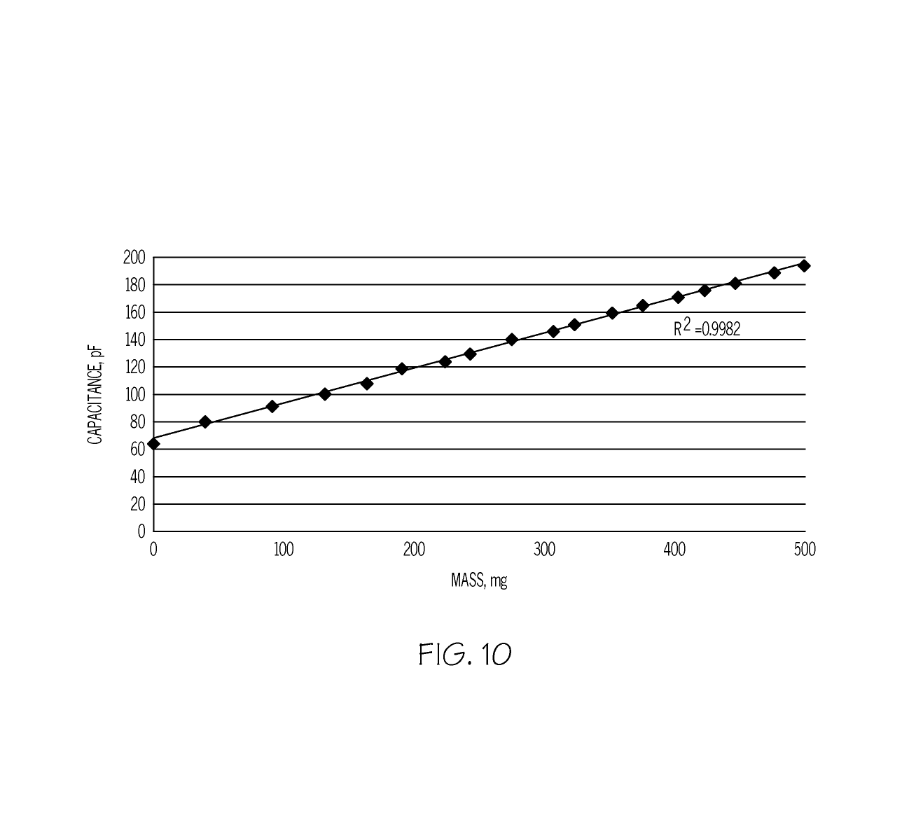

The capacitance of the interdigitated electrode structure was measured using a LCR821 meter. In air, the device had a capacitance of 63.9 pF. When fully submerged in water, the device had a capacitance of 321.3 pF. Additionally, the prototype device was evaluated by adding drops of water to the surface of the device so that the capacitance could be measured as a function of mass. Since the water did not wet the surface very well, the water beaded up so that the surface area of the water in contact with the device increased as the mass increased. A plot of the measured capacitance of the interdigitated electrode versus mass is shown in FIG. 10, which demonstrates a linear response of the interdigitated electrode sensor to variable quantities of water.

Turning now to the concept of electrical conductivity sensors, electrical conductivity (EC) is an important soil and water parameter that is used to determine soil salinity and sodium content in soils. The EC is typically reported as either a measure of a standard extract (ECₛₑ) or of water itself (EC_{w}). More recently, however, EC has been evaluated as a rapid means for the estimation of other soil characteristics, such as topsoil depth, total ion concentration and soil water holding capacity.

To measure EC, two bare electrodes need to be placed in Ohmic contact with the soil being tested. Then, the resistance is measured between the two electrodes. Electrical conductivity is inferred from the resistance measurement. The geometry of the electrodes can be used to determine electrical conductivity. PCB technology can readily be employed to measure EC.

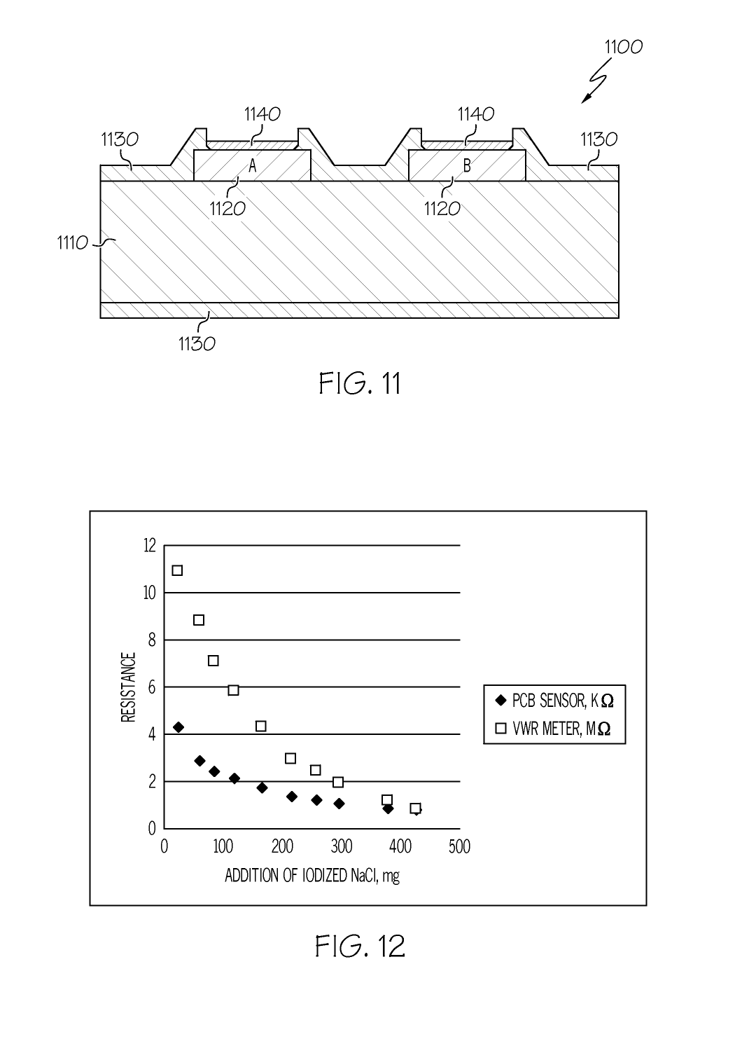

FIG. 11 shows a cross-section view of an EC sensor integrated in PCB 1100 according to an illustrative embodiment. According to an illustrative embodiment, for the soil EC sensor in PCB technology, the FR4 substrate 1110 serves as a rigid backbone for the sensor. The exposed Cu pads 1120 (with a surface finish 1140) serve as the two electrodes for EC measurement. The solder mask coating 1130 provides a nonconductive moisture barrier between and around the electrodes “A” and “B”.

For illustrative purposes, a two-point resistance measurement configuration was used with the PCB sensor to measure the electrical conductivity of water with added NaCl. The results are shown in FIG. 12 which illustrates a plot of a PCB EC sensor response to the addition of NaCl in soil. A response of a commercially available VWR meter is also shown in FIG. 12 for comparison purposes. Although the resistance of the solution is nonlinearly proportional to the mass of the added NaCl, the PCB EC sensor had a similar response to that of the commercially available. In contrast to the VWR meter, however, the PCB EC sensor is much less expensive, easier to handle and fabricate.

According to an illustrative embodiment, a capacitive fringing field interdigitated electrode sensor and an EC sensor are integrated into PCB to sense signals indicative of the chemical properties and composition of soil and aqueous solutions. Such sensing structures may be fabricated with a low-cost commercial printed circuit board process. The interdigitated electrode sensor and the EC sensor provide signals that may be used in electrochemical impedance spectrometry, described in more detail below. The interdigitated electrode sensor may be copper clad and covered with a solder mask. The EC sensor may be copper clad but exposed. A temperature sensor may be integrated onto the same PCB, such that measurements may be calibrated with the environmental temperature. According to illustrative embodiments, chemical properties that may be sensed may include volumetric water content, salt content (e.g., NaNO₃, KCl, and NaCl), nitrate (NO₃) content and nitrite-nitrogen content.

Self-hydration of salt ions, also called water shells and ionic atmospheres, results in ion-dipole polarization, resulting in frequency dependent changes in the complex permittivity and hence the complex impedance. When salt concentrations are low, the water shells are large, resulting in the relaxation frequency (the onset of the polarization effect) occurring at low frequency. As the salt concentration increases, however, the size of the water shells decreases, resulting in a smaller effective ion radius and an increase in the relaxation frequency. This effect can be measured electrically and used to determine the chemical constituents in aqueous solutions through a technique called electrochemical impedance spectrometry (EIS). In various salt solutions, this effect on measurable impedance due to polarization has been successfully used at relatively low frequencies: 10 KHz-1 MHz (KCl and NaCl in aqueous solution), <70 MHz (NaNO₃ in soil), 5 Hz-13 MHz (NO₃ in soil), and 500 KHz (NaNO₃ and NH₄NO₃ in water).

For soils, the frequency domain form of the electrical permittivity is given as the complex quantity:

ε^{*}=ε_{O}εᵣ¹−jε_{O}εᵣ^{″} (4)

where ε^{*} is the complex permittivity, ε_{O} is the permittivity of free space, εᵣ¹ is the real part of the permittivity, and εᵣ^{″}is the imaginary part and represents the dielectric losses (relaxation and conduction) due to dissipation in the material. Further expanding the model,

$${ɛ}_{r}^{″} = {ɛ}_{d}^{″} + \frac{σ}{{ωɛ}_{o}} \qquad ( 5 )$$

where ε_{d}^{″}is the relaxation component and σ is the electrical conductivity of the material. Dissolved salt ions in the soil will affect the electrical conductivity and the relaxation component. The relaxation component results in an increase in the measurable capacitance at the polarization frequency of dissolved ions.

Substituting (5) into (4) results in:

$${ɛ}^{*} = {ɛ}_{0} {ɛ}_{r}^{′} - {jɛ}_{o} ( {ɛ}_{d}^{″} + \frac{σ}{{ωɛ}_{o}} ) \qquad ( 6 )$$

which reduces to

$${ɛ}^{*} = {ɛ}_{0} {ɛ}_{r}^{′} - {jɛ}_{o} {ɛ}_{d}^{″} + \frac{σ}{jω} . \qquad ( 7 )$$

The effects of the complex permittivity on capacitive impedance is depicted by considering the impedance a simple parallel capacitance. Assume a given capacitance, C, where A represents the equivalent parallel plate area and d represents the separation distance between parallel plates. A pseudo-capacitance may be defined as:

$$C = \frac{A {ɛ}^{*}}{d} \qquad ( 8 )$$

which becomes:

$$C = \frac{A}{d} {ɛ}_{o} {ɛ}_{r}^{′} - j \frac{A}{d} {ɛ}_{o} {ɛ}_{d}^{″} + \frac{A σ}{jω d} . \qquad ( 9 )$$

The impedance is therefore:

$$Z ( jω ) = \frac{1}{jω C} = \frac{1}{jω \frac{A}{d} {ɛ}_{o} {ɛ}_{r}^{′} + ω \frac{A}{d} {ɛ}_{o} {ɛ}_{d}^{″} + \frac{{A}_{σ}}{d}} \qquad ( 10 )$$

and the admittance becomes:

$$Y ( jω ) = jω \frac{A}{d} {ɛ}_{o} {ɛ}_{r}^{′} + ω \frac{A}{d} {ɛ}_{o} {ɛ}_{d}^{″} + \frac{{A}_{σ}}{d} \qquad ( 11 )$$

The admittance can be modelled by electronic circuitry. Furthermore, the circuit model for the sensor (10) can be connected in series with a resistor and driven by a constant amplitude, variable frequency voltage source. Then, by measuring the voltage across the EC sensor and comparing its amplitude and phase delay with the input signal, as a function of frequency, EIS (electrochemical impedance spectroscopy) can be employed to estimate the chemical constituents of the soil.

The previously discussed interdigitated electrode and electrical conductivity sensors implemented in low-cost commercial PCB technology can be adapted to EIS for measuring several soil properties and aqueous solution properties by combining them onto a common substrate with a temperature sensor. The PCB fringing field sensor that utilizes the soldermask covering can be connected with a series resistor and swept in frequency to measure the complex impedance. In addition to preventing shorting between the electrodes, the soldermask layer acts as a DC blocking capacitor between the capacitive sensor and the EC detection circuitry. This architecture has the advantage of a built-in blocking capacitor in series with the electrodes and solution, which eliminates the Helmholtz double layer that would otherwise form at exposed metal electrodes and limit the detection of low frequency polarizations. Additionally, the electrical conductivity sensor in PCB technology is used to determine the DC electrical conductivity, a, of the soil, further enhancing the EIS measurement of volumetric water content and nitrate content. Further, a miniature electronic temperature sensor may be integrated onto the PCB substrate and used to calibrate the readings over the environmental temperature range.

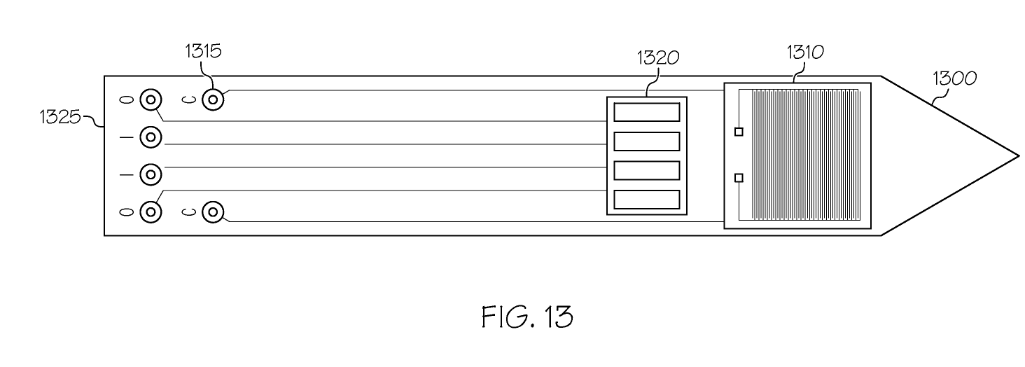

FIG. 13 illustrates a device 1300 for measuring chemical properties according to an illustrative embodiment. The device includes an interdigitated capacitance sensor 1310 and an EC sensor 1320 integrated into a PCB 1300. The PCB 1300 includes a pointed end for insertion into soil. For measurements of an aqueous solution, the PCB 1300 may simply be partially or entirely submerged into the solution. The PCB 1300 also includes capacitance measurement connectors 1315 and conductive measurement connectors 1325. These connectors allow the measured capacitance and electrical conductivity signals to be output, e.g., to EIS circuitry for determining the chemical composition of the soil or aqueous solution.

Although not shown in FIG. 13 in the interest of simplicity of illustration, it should be appreciated that a temperature sensor may also be integrated into the PCB 1300, with connectors for outputting a sensed temperature that enables the measured impedance and electrical conductivity to be calibrated to a sensed environmental temperature. This calibration may be performed, e.g., by an external processor. The temperature sensor may be implemented with any commercially available temperature sensing device that may be integrated into the PCB 1300.

According to the embodiment described above, a fringing field interdigitated electrode sensor and an EC sensor fabricated on a PCB may be used to produce a signal indicative of the chemical composition/properties of soils and aqueous solutions. Such sensors are low cost and easy to install. Such devices may be buried within soil, which makes them ideal for agricultural applications. The devices are reliable and accuracte in adverse field conditions. Such sensors may also be integrated into devices, such as RFID tags, such that measurements may be received remotely. This makes the measurements easy to download to hand held devices for further processing.

According to another embodiment, a fringing field interdigitated electrode sensor may be fabricated on a PCB sensor for sensing the accumulation or presence of ice or frost (herein collectively referred to as the “accumulation of ice”).

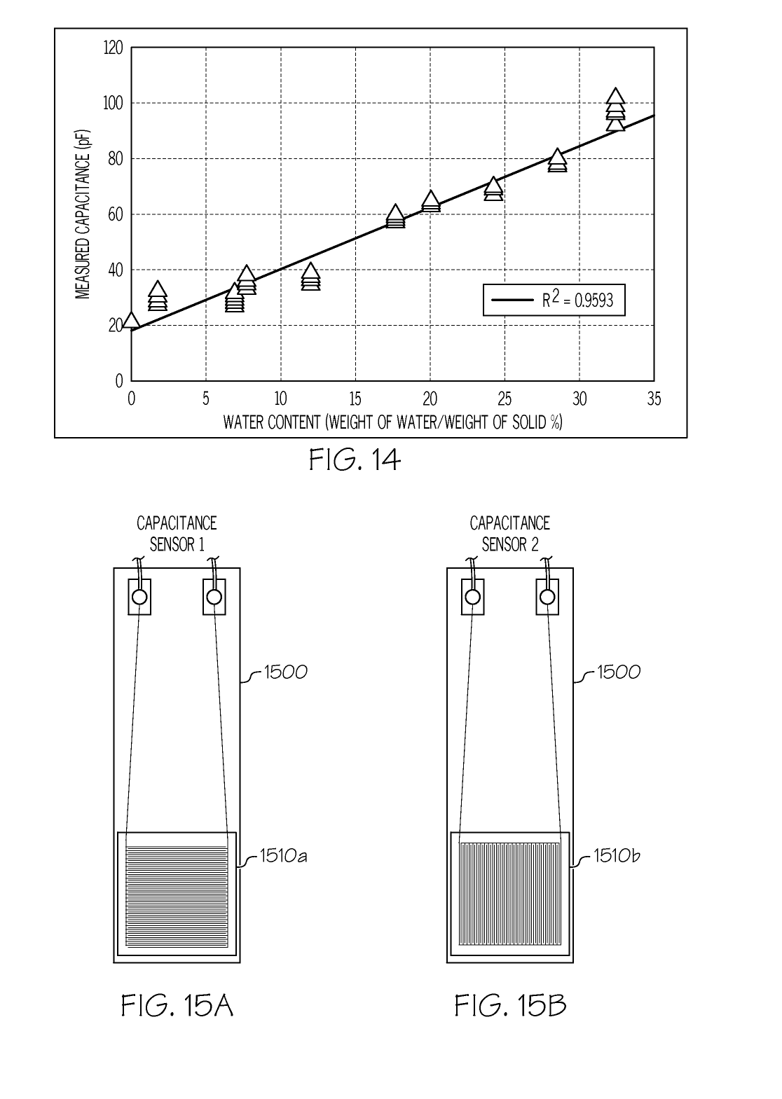

As an aid to understanding how a fringing field interdigitated electrode sensor may be used to detect the accumulation of ice, consider a PCB interdigitated electrode sensor that was designed and used to measure the moisture content (MC) of soil. This sensor, with an active sensing area of 83.8 mm by 26.7 mm in size, was fabricated with an interdigitated electrode array on one side. This device was purposely fabricated to have the electrically insulated connection points 6 cm away from the sensing pad so that the sensor could easily be submerged in the test medium. The backside of the device had an electrically floating Cu pad directly behind the electrode array. The backside of the device was coated with solder mask. The sensor electrode array was approximately 10 mm by 8.5 mm and consisted of 29 interdigitated electrode teeth, where each tooth overlapped adjacent teeth by 9.7 mm. Additionally, the rigidity of the sensor allowed for easy handing during testing in soil mixtures. In air, the capacitance of the sensor was measured as 16.5 pF. When fully submerged in water at room temperature, a capacitance of 152.3 pF was measured. The sensor was used to measure the MC of soil, as shown in FIG. 14, which illustrates a nearly linear sensor response as a function of MC.

Flexible PCB fringing field sensors were also developed and demonstrated for detecting the presence of water, using a commercially available flexible PCB process. Examples of flexible PCB fringing field sensors are shown in FIGS. 15a and 15b. In FIG. 15a, the interdigitated capacitance sensor 1510a is horizontally arranged on the PCB 1500. In FIG. 15b, the interdigitated electrode sensor 1510b is vertically arranged on the PCB 1500. It should be appreciated, however, that such interdigitated electrode sensors may be arranged in any geometric configuration with the PCB. These sensors were realized in a two-layer commercial Kapton® flexible PCB process with the same interdigitated electrode configuration as the rigid sensor shown in FIG. 9b. These sensors had a measured capacitance of approximately 70 pF in air and 218 pF in water (at 22° C.).

The relative permittivity of air and many gasses close to atmospheric pressure is approximately 1. Liquid water, however, has a relative permittivity of approximately 80, while ice has a relative permittivity of approximately 4.2. Interdigitated electrode capcitiance sensors will experience a large, abrupt change in measurable capacitance when water on them changes to ice. A similar change in measurable capacitance will occur if ice deposits on the sensor without going through the liquid phase, such as the accumulation of frost.

To verify this, identical flexible horizontal PCB sensors were fabricated. First, their capacitance in air was measured: 70.6 pF and 70.7 pF, respectively. Then, both sensors were submerged in tap water in plastic cups and their capacitances were measured: 244 pF and 234 pF, respectively. The cup containing the first sensor submerged in water was placed in a freezer at −40° C. for approximately 14 hours, while the other sensor remained submerged in tap water at room temperature. Then, the capacitance of both sensors was again measured. The sensor submerged in water had a capacitance of 256 pF, slightly higher than measured before and likely due to the PCB absorbing moisture. The sensor frozen in ice had a measured capacitance of only 88.5 pF, significantly less than the capacitance of the sensor still submerged in water. Although the capacitance of PCB fringing field interdigitated electrode sensors has been shown to decrease with temperature, the primary reason for the large decrease in capacitance is due to the large difference in the dielectric constant of ice as compared to water. Based on these results, the PCB fringing field sensor described herein is useful for the detection of ice, as ice accumulation will cause a large decrease in capacitance detected by the PCB fringing field sensor.

According to this embodiment interdigitated electrode capacitance sensors may be used for detecting the accumulation of ice for a number of applications. The interdigiated electrode sensor may be fabricated on a rigid, semi-rigid, or flexible substrate depending on the desired application. The PCB may be flexible to allow the sensor to be conformably attached or adhered to planar or non-planar surfaces for the purpose of detecting the presence or accumulation of ice or frost.

Applications of sensors according to this embodiment include but are not limited to the detection of the accumulation of ice on plants, the detection of the accumulation of ice associated with arcraft structures (e.g., wings, airframes, tail sections, control surfaces, landing gear, windshields, windows, propellers, rotor blades and related connecting structures), the detection of the accumulation of ice on spacecraft structures (e.g., external tanks, rocket bodies, control surfaces, hoses, and launch gantries), the detection of the accumulation on manmade surfaces and structures, such as roads, bridges, sidewalks, parking lots, buildings, towers, tanks, antennas and ships, and the detection of the accumulation of ices on or in temperature lowering equipment (e.g., refrigeration equipment, compressors, vacuum systems and pumps, refrigerators, freezers, air conditioners and heat pumps).

According to this embodiment, the sensor may be fabricated on a PCB including other electrical components or without other electrical components. Also, the device may be integrated into an RFID tag for remote sensing applications.

According to illustrative embodiments, soil and aqueous solution composition sensors and ice accumulation sensors are provided on a printed circuit board. Positions and sizes of the sensors components, such as the interdigitated electrode tooth length, width and spacing, can be tailored over a very broad range using PCB technology as needed to accommodate soil particle sizes, surfaces on which ice may accumulate, etc. Integrating these sensors onto printed circuit boards provides a low-cost wavy of realizing very large sensor active areas or active area arrays using commercial available PCG fabrication processes. Additionally, microelectronics can easily be integrated with the PCB implementation.

While the invention has been described with reference to preferred and example embodiments, it will be understood by those skilled in the art that a number of modifications, additions and deletions are within the scope of the invention, as defined by the following claims.

What is claimed is:

1. A device, comprising:
a capacitive fringing field interdigitated electrode sensor integrated into a printed circuit board and configured to sense an electrical impedance of soil; and
an electrical conductivity sensor integrated into the printed circuit board and configured to sense an electrical conductivity of surrounding soil, wherein the sensed electrical impedance and the sensed electrical conductivity are indicative of chemical properties of the soil.

2. The device, further comprising a temperature sensor integrated into the printed circuit board and configured to sense an environmental temperature.

3. The device of claim 2, wherein the sensed electrical impedance and the sensed electrical conductivity are calibrated with the sensed temperature.

4. The device of claim 1, further comprising a soldermask covering the fringing field interdigitated electrode sensor.

5. The device of claim 1, wherein the electrical conductivity sensor is exposed.

6. The device of claim 1, wherein the electrical conducvitty sensor has a surface finish.

7. The device of claim 1, wherein the chemical properties include at least one of water content, salt content, nitrate content, and nitrate-nitrogen content.

8. The device of claim 1, wherein the salt content includes at least one of NaNO₃, KCl, and NaCl.

9. A device, comprising:
a capacitive fringing field interdigitated electrode sensor integrated into a printed circuit board and configured to sense an electrical impedance of an aqueous solution; and
an electrical conductivity sensor integrated into the printed circuit board and configured to sense an electrical conductivity of surrounding soil, wherein the sensed electrical impedance and the sensed electrical conductivity are indicative of chemical properties of the aqueous solution.

10. The device of claim 9, wherein the chemical properties include at least one of salt content, nitrate content and nitrite-nitrogen content of the aqueous solution.

11. The device of claim 10, wherein the salt content includes at least one of KCl, NaCl and NaNO₃.

12. A device, comprising:
a printed circuit board; and
a capacitive fringing field interdigitated electrode sensor integrated into the printed circuit board and configured to sense electrical impedance, wherein an abrupt decrease in the sensed electrical impedance is indicative of an accumulation of ice.

13. The device of claim 12, wherein the printed circuit board is rigid or semi-rigid.

14. The device of claim 12, wherein the printed circuit board is flexible allowing the device to be conformally attached or adhered to planar or non-planar surfaces for the detecting the accumulation of ice.

15. The device of claim 12, wherein the device is adapted to detect accumulation of ice associated with plants.

16. The device of claim 12, wherein the device is adapted to detect accumulation of ice associated with aircraft structures.

17. The device of claim 12, where the device is adapted to detect the accumulation of ice associated with spacecraft structures.

18. The device of claim 12, wherein the device is adapted for detecting the accumulation of ice associated with at least one of manmade surface structures, vehicles, buildings, towers, and antennas.

19. The device of claim 12, wherein the device is adapted for detecting the aaccumulation of ice on or in temperature lowering equipment.

20. The device of claim 12, wherein the device is integrated into an RFID tag for remote sensing applications.
